(19) United States
(12) Patent Application Publication
(10) Pub. No.: US 2002/0013880 A1
(43) Pub. Date: Jan. 31, 2002

(54) Integrated circuit with flash bridge and autoload

(76) Inventors: Steffen Gappisch, Zuerich (CH); Hans-Joachim Gelke, Zuerich (CH)

Correspondence Address: U.S. Philips Corporation, 580 White Plains Road, Tarrytown, NY, 10591, US

(21) Appl. No.: 09/891,448

(22) Filed: Jun. 26, 2001

(30) Foreign Application Priority Data
Jun. 27, 2000 (EP) 00113611.8

(51) Int. Cl. G06F 12/00

(52) U.S. Cl. 711/103; 711/154

(57) ABSTRACT

This invention relates to the structure and design of integrated circuits (ICs), in particular to the embedding or integration of a non-volatile, so-called flash memory into ICs. To solve the issues created by speed differences of the embedded flash memory compared to the other components on an IC, in particular the microprocessor and/or other memory on the IC, a specific writing interface is provided for the flash memory which makes the latter appear like standard memory from a software viewpoint. This writing interface includes a bank of registers (2) between flash memory (7) and microprocessor (6), essentially being operated by a write controller (1) and a flash bus arbiter (8) and acting, in principle, as a intermediate buffering mechanism controlled by a state machine.

The present invention relates to the structure and design of integrated circuits (ICs), in particular to the embedding or integration of a non-volatile or flash memory into an IC with one or more microprocessors. This embedding or integration of non-volatile memory with a microprocessor is often desired or even required for ICs to be used in mobile phones, personal digital assi-stants, in GPS applications for automobile or other navigation purposes.

Embedding a flash memory into a chip leads to certain problems that have to be solved before such integration exhibits the expected advantages. One of the issues is that, by “nature”, the access times of usual flash memories differ significantly from the access times of the other components on the IC.

A particular problematic aspect of flash memory is that its hardware interfaces for writing are different to the interfaces of SRAMs or DRAMs in the way that the flash memory needs some servicing utilities, namely the load cycles and the program cycles. Therefore, writing into the flash memory is not transparent to other memory from the software point of view. Special software driver routines must be provided to write to the flash memory. These software driver routines unfortunately have an adverse effect on the flash memory's performance during writing. Here, the present invention provides a solution by improving the function of embedded flash memory in a microprocessor environment on an IC, with the emphasis on maximizing performance. In principle, this is achieved by making write accesses to the flash memory quasi transparent to writing to other memories.

The present invention solves above the identified issues essentially with the following measures:

A bank of intermediate write data holding registers is provided in which the data from the IC's microprocessor is stored (or buffered) before it is transferred to the flash memory.

If the flash memory data width (or its bus width) m is a multiple of the microprocessor's data width (or its bus width) n, the transfer is automatically started as soon as the microprocessor has written into the last holding register.

The data holding registers are mapped to an address range. This means, if the microprocessor writes into any of the addresses in said address range, the data holding register get accessed. The least significant address bits select an individual holding register, the bits immediately above are used as the address into the flash memory.

If the microprocessor tries to write into one of the holding registers a second time before the data transfer to the flash memory is completed, a wait cycle is inserted into the microprocessor bus cycle until the data transfer to the flash memory is completed.

Additionally or alternatively, in case the microprocessor wants to transfer from the write data holding registers to the flash memory before the last holding register is written into, this transfer can be forced by the microprocessor.

The described method is especially efficient in systems where the flash memory's data width m is a multiple of the microprocessor's data width n, since the write data holding registers are required anyway. In cases were m equals n, only one data holding register is necessary. However, even in this case, several data holding registers would increase the performance, since the flash memory could be accessed by bursts of data.

The above measures make writing into the flash memory look like writing to an SRAM.

In the following, an exemplary embodiment of the invention will be shown in some detail and with some drawings. In these show

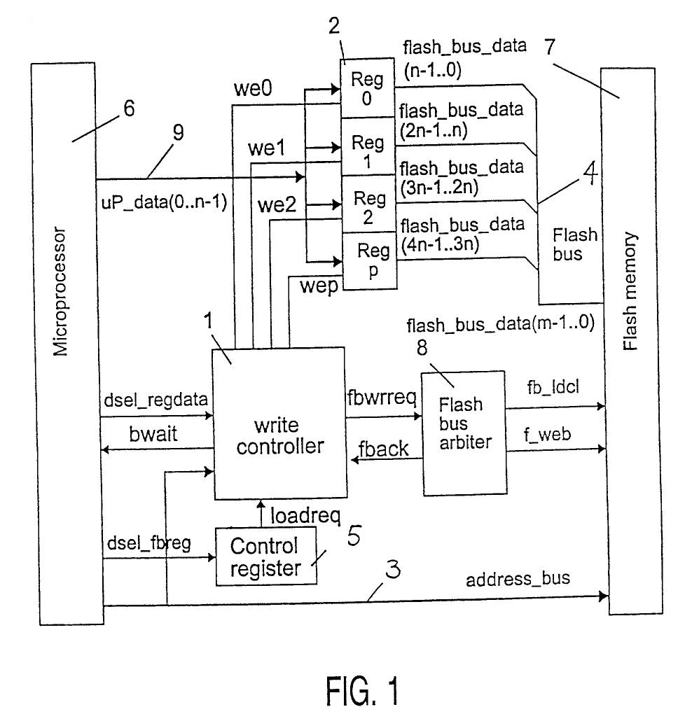

FIG. 1 the detailed layout of an embodiment of the invention, and

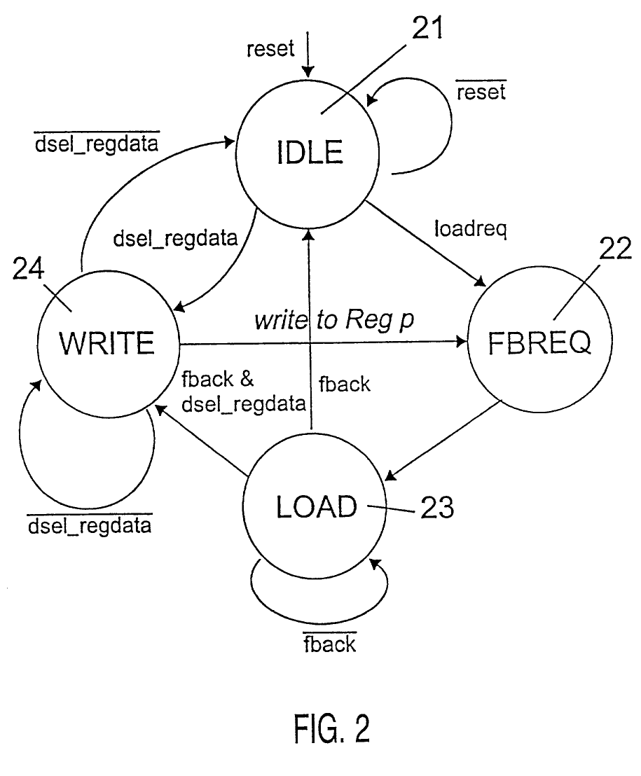

FIG. 2 the state diagram of the write controller 1 in FIG. 1.

The general layout in FIG. 1 shows, as essential components:

a microprocessor 6 with its data bus 9 and its address bus 3,

a flash memory 7 with its flash bus 4,

a bank 2 of holding registers Reg 0 . . . Reg p between the micro-processor's data bus 9 and the flash bus 4,

a flash memory write controller 1,

a flash bus arbiter 8, and

a control register 5.

As indicated above, the data bus 9 of the microprocessor 6 has a width of n, e.g. n=32, which is less than the width m, e.g. m=128, of the flash bus 4. Each of the holding registers Reg 0 . . . Reg p in the register bank 2 also has a width of n, here n=32. In the present case, four holding registers Reg 0 . . . Reg 3 are provided in register bank 2, but, if higher speeds are desired, a multiple of four may be provided. When the microprocessor 6 sends write data over bus 9, the four 32-bit holding registers Reg 0 . . . Reg p latch the incoming data.

The holding registers Reg 0 . . . Reg p are addressed such that the more significant address bits are directly connected to the flash memory 7.

The flash memory 7 is connected to the bank of holding registers 2 via the flash bus 4. Since there may be other requestors (not shown in this drawing) connected to the flash bus, an arbiter 8 is required. Before the contents of the holding registers Reg 0 . . . Reg p of bank 2 can be transferred to the flash memory 7, a request must be sent to the flash bus arbiter 8. This is accomplished by the write controller 1 by activating signal fbwrreq. The arbiter 8 confirms the transfer of data to the flash memory by issuing signal fback. This is a kind of handshaking system between the flash bus 4 or memory 7 and the write controller 1.

The addresses of the holding registers Reg 0 . . . Reg p of bank 2 are in the addressing map of the flash memory 7. For this example, addressing is considered sequential. Thus, after writing into Reg p, the flash memory write controller 1 jumps to the next state (state FBREQ 22, cf. FIG. 2), in which state the flash bus 4 is requested for writing and the write controller 1 issues signal fbwrreq. Right after that, the write controller 1 unconditionally jumps to the LOAD state (23 in FIG. 2), where it waits for the flash bus arbiter 8 to acknowledge the transfer of data to the flash memory 7. Thus, an automatic load function, as addressed above, is performed.

The flash memory write controller 1 can be considered a state machine. The state diagram of this machine is shown in FIG. 2.

The state machine has mainly two functions: The first function is to control transfers from the microprocessor 6 to the four data holding registers Reg 0 . . . Reg p of bank 2. This is called a WRITE operation.

The second function is to transfer the data from the data holding registers in bank 2 to the flash bus 4. This is called a LOAD operation. A brief description of the various states or operations, resp., of the write controller 1 follows. WRITE operation:

After reset, the memory write controller state machine is in the IDLE state 21. When the microprocessor addresses the data holding registers Reg 0 . . . Reg p by activating the flash memory chip select signal dsel_regdata, the state machine switches to the WRITE state 24. On back-to-back write accesses (dsel_regdata remains active for multiple cycles), the state machine may remain in the IDLE state 21. A WRITE state may also be immediately preceded by a LOAD state 23.

If a write access by the microprocessor to data holding registers Reg 0 . . . Reg p arrives during an active flash bus load cycle, wait cycles (signal bwait) are inserted into the microprocessor bus cycle. After the load cycle is completed, bwait is removed and a write cycle is executed, i.e. microprocessor bus data are written to the registers Reg 0 . . . Reg p. LOAD operation:

Be it assumed that the state machine is in the WRITE state 24. Now, after addressing the last holding register of register bank 2 (FIG. 1), i.e. Reg p, the state machine jumps to the FBREQ state 22, in which a write request is sent to the flash bus arbiter 8 (FIG. 1). As soon as this is done, the state machine switches unconditionally to the LOAD state 23. In the LOAD state 23, the state machine waits for the flash bus arbiter 8 to acknowledge the transfer of the flash bus data to the flash memory 7. When the flash bus arbiter 8 grants the flash bus write request, it activates signals fb_ldcl and f_web to strobe the data from the registers into the flash memory 7. When the flash bus arbiter 8 returns signal fback to the controller 1, meaning that data has been transferred to the flash memory 7, the state machine jumps either to the IDLE state 21 or the WRITE state 24. It jumps to the WRITE state 24, when another write from the microprocessor 6 to bank 2 is pending. Non-automatic LOAD:

As described above, load cycles occur automatically, if the flash memory write accesses occur sequentially, but it may be necessary to force load cycles if write accesses are not sequential. This is done by writing a bit into the control register 5. Signal loadreq is issued to the write controller 1 and a load operation is performed.

If the microprocessor 6 writes to the control register 5 while the state machine, i.e. the write controller 1, is in the IDLE state 21, the control register is immediately updated. If the microprocessor 6 writes to the control register 5 while the controller 1 is in the LOAD state 23, wait states are inserted into the microprocessor cycle until the state machine leaves the LOAD state 23. Only after the load operation is completed, the control registers are updated.

Though the invention has been shown in a single embodiment only, the person skilled in the art can easily introduce modifications and variations according to the above-described principles without departing from the gist of the invention and the scope of the appended claims.

1. An integrated circuit system with at least one microprocessor (6) and at least one memory, wherein
said memory is a non-volatile or flash memory (7) operationally linked by a flash bus (4) to said microprocessor's data bus (9), and said flash bus (4) has a width different from said microprocessor bus (9) width, including
register means (2) for buffering data to be written into said flash memory (7), and
control means (1) for controlling the write activity into said flash memory (7).

2. The integrated circuit system according to claim 1, wherein
the flash bus (4) is a dedicated bus having a width m greater than the width n of the microprocessor data bus (9), in particular m being a multiple of n, and
the register means (2) comprises a number p of registers, (Reg 0 . . . Reg p), each being n bit wide, such that p*n=m.

3. The integrated circuit system according to claim 1 or 2, wherein
the control means (1) provides for an automatic transfer of the data buffered in the register bank (2) into the flash memory (7) as soon as the last register (Reg p) has received its data from the microprocessor (6).

4. The integrated circuit system according to claim 1 or 2, wherein
alternatively, a non-automatic, controlled transfer of the data from the register bank (2) into the flash memory (7) is performed under control of the control means (1) independent of the status of the last register (Reg p).

5. The integrated circuit system according to one or more of the preceding claims, further comprising
arbiter means (8) for arbitrating accesses to the flash bus (4).

6. The integrated circuit system according to one or more of the preceding claims, wherein
one or more of the registers (Reg 0 . . . Reg p) are mapped to an address range of the flash memory (7) and
the most significant addresses in that address range are used to address said flash memory (7).

7. The integrated circuit system according to one or more of the preceding claims, further comprising
a control register (5) for receiving commands from the microprocessor and providing an output signal when a flash memory load operation should be perfomed.

8. The integrated circuit system according to one or more of the preceding claims, wherein
the control means (1) introduces one or more wait states into the microprocessor's cycles whenever said microprocessor (6) tries to update the registers (Reg 0 . . . Reg p) before the data transfer into the flash memory (7) is completed.

9. The integrated circuit system according to one or more of the preceding claims, wherein
a handshaking scheme is executed between the arbiter means (8) and the control means (1) to synchronize the data transfer from the register bank (2) with the availability of the flash bus (4).

10. The integrated circuit system according to one or more of the preceding claims, wherein
the control means (1) is a state machine with four states, in par-ticular an IDLE state, a FBREQ (Flash Bus Request) state, a LOAD state, and a WRITE state.
